(19) United States
(12) Patent Application Publication
(10) Pub. No.: US 2007/0141265 A1
(43) Pub. Date: Jun. 21, 2007

(54) Process for controlling the density, conformation and composition of the hydrophilic layer of a polyurethane composite

(76) Inventor: Timothy Thomson, West Newbury, MA (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 10/588,349

(22) PCT Filed: Feb. 2, 2005
(86) PCT No.: PCT/US05/03388

§ 371 Date: Aug. 2, 2006

Related U.S. Application Data
(60) Provisional application No. 60/541,156, filed on Feb. 2, 2004.
(60) Provisional application No. 60/545,976, filed on Feb. 19, 2004.

(51) Int. Cl. B05D 3/02

(52) U.S. Cl. 427/384

(57) ABSTRACT

A process of making a foam composite of desired pore size and conformation is provided. An emulsion of a hydrophilic polyurethane prepolymer which upon curing forms a substantially open cell hydrophilic polyurethane polymer foam is prepared and contacted with an open cell hydrophobic polyurethane foam having a plurality of surfaces defining a plurality of pores. The hydrophilic polyurethane prepolymer emulsion is then cured while by contacting with a gas at elevated temperature for a period of time sufficient to form a coating of substantially open cell hydrophilic polyurethane polymer foam on the hydrophobic polyurethane foam.

### BACKGROUND OF THE INVENTION

Thomson in U.S. Pat. No. 6,617,014 teaches the composition and process by which a hydrophilic polyurethane can coat a substantially open cell foam. One of the processes taught in that patent is to emulsify an aqueous phase with a hydrophilic prepolymer and then by means of a nip roller, force the emulsion into the matrix of an open cell hydrophobic polyurethane foam. After curing, the process produces a composite having the strength, structure and other aspects of the open cell polyurethane scaffold and the beneficial properties of the hydrophilic polyurethane as a coating. It is known that the temperature at which the hydrophilic polyurethane is cured to some degree controls the density and the cell structure of the resultant foam coating. The composites can be used in a number of product areas including bioremediation of waste or otherwise contaminated water. The composite can also be used in certain medical devices.

### DETAILED DESCRIPTION OF THE INVENTION

It has been found that by controlling the temperature of the process immediately after application of the hydrophilic prepolymer to the hydrophobic scaffold and before the prepolymer is polymerized, the density and the confirmation of the hydrophilic layer can be controlled. Specifically, if the scaffold on which the hydrophilic prepolymer has been applied is contacted with live steam or hot air, the hydrophilic polyurethane forms into a low density porous layer. In contrast, if cold air is pumped through the chamber a dense, nearly hydrogel layer is produced.

In a further embodiment of the invention, additives, e.g., —activated carbon, can be coated on the surfaces of the pores of the substantially open-call polyurethane foam. In this method, the additive, e.g. activated carbon, is contacted with a low molecular weight hydrocarbon gas, e.g. butane, and then slurried in a fluid, e.g. water. The slurry is emulsified with the polyurethane prepolymer and the mixture is then deposited on the surfaces of the pores of the substantially open-cell polyurethane foam scaffold. The composite is then exposed to live steam or hot air so that the emulsion is heated to a high temperature before it gels. The hydrocarbon absorbed in the activated carbon is vaporized and stripped out of the composition by the application of the steam or hot air. This opens up the pores of the carbon. The polymer then gels, permanently fixing the activated carbon in the hydrophilic foam layer within the open-call scaffold, the carbon having open pores produced by the outgassing.

While Thomson, U.S. Pat. No. 6,617,014, deals specifically with hydrophilic polyurethane coated on hydrophobic foams, the method of this invention is also effective for coating hydrophobic prepolymers on hydrophobic polyurethane foams. The carbon-impregnated foam retains much of the activity of the untreated carbon.

The composites which are improved by the methods of the present invention, the methods for making these composites and the numerous end uses for the composites are described in U.S. Pat. No. 6,617,014 and in related U.S. Patent Publication US-2002-0018884-A1 and its PCT counterpart WO/01/74582 A1. The details of same are therefore known to the art and are specifically referred to and incorporated herein.

Steam is a preferred gas for heating the hydrophilic prepolymer because it is inexpensive and its condensation product, liquid water, is compatible with the process and the ultimate end product. Saturated or superheated steam may be used.

The temperature of the composite containing the prepolymer is desirably raised above 40° C. Preferably it is raised to from 50° C. to 200° C. and most preferably from 60° C. to 150° C. The pressure of the steam is desirably above atmosphere. Preferably it is from 5 psig to 500 psig and most preferably from 10 psig to 300 psig.

The steam treatment can be commenced at any time after application of the prepolymer. Good results are obtained if the treatment commences within one minute of such contact and best results are obtained if contact is commenced within 10 seconds of such contact.

Gases such as air, nitrogen and carbon dioxide or other gases compatible with the composite can also be used. The temperatures, pressures, hiatus before application and treatment time are similar to those discussed above.

The additives which can be used include active carbon in its many forms, zeolites, silica, etc. as will be known to those skilled in the art. Typically, they are in finely divided form.

The low-molecular weight hydrocarbons with which the activated carbon is contacted include propane, butane, pentane and similar saturated hydrocarbons. Other non-reactive gases can also be used.

The temperature, pressure and volume of the steam or gas the hiatus in applying it and the duration of the treatment can be varied by those skilled in the art to control the density and confirmation of the hydrophilic layer in the composite.

### EXAMPLE 1

An emulsion of 1 part water to which is added 0.05% Pluronic L62 and 1 part Hypol 2002 is produced in a pin mixer and deposited on a 30 ppi polyether polyurethane reticulated foam by means of nip rollers. Within 2 seconds of the first contact of the aqueous phase and the prepolymer, the composite is exposed to live steam in such a way as to immediately elevate the temperature of the composite to 100° C. The steam is in contact with the composite for a minimum of 15 seconds during which time it fully cures as evidenced by a lack of tackiness. Upon microscopic examination, it is determined that a porous hydrophilic coating is produced.

### EXAMPLE 2

The composite is prepared as in Example 1, except that the foam enters a chamber to which is pumped air at 4° C. The composite is exposed to the cold air for 30 minutes. Since the foam is still tacky, it is understood that the hydrophilic polyurethane is not fully cured. It is allowed to cure at room temperature for an additional 30 minutes before analysis. Upon microscopic examination, it is determined that a nonporous hydrophilic coating is produced.

### EXAMPLE 3

An activated carbon (NUCHAR RGC Powder, 879-R-02) was supplied by the Chemical Division of Westvaco, Covington, Va. It was pretreated by exposing 100 grams to 10 grams of butane gas. The carbon was shaken in a bottle to ensure complete absorption of the butane. The carbon was slurred in 1 liter of tap water. One drop of dishwater soap was added to aid in the dispersion.

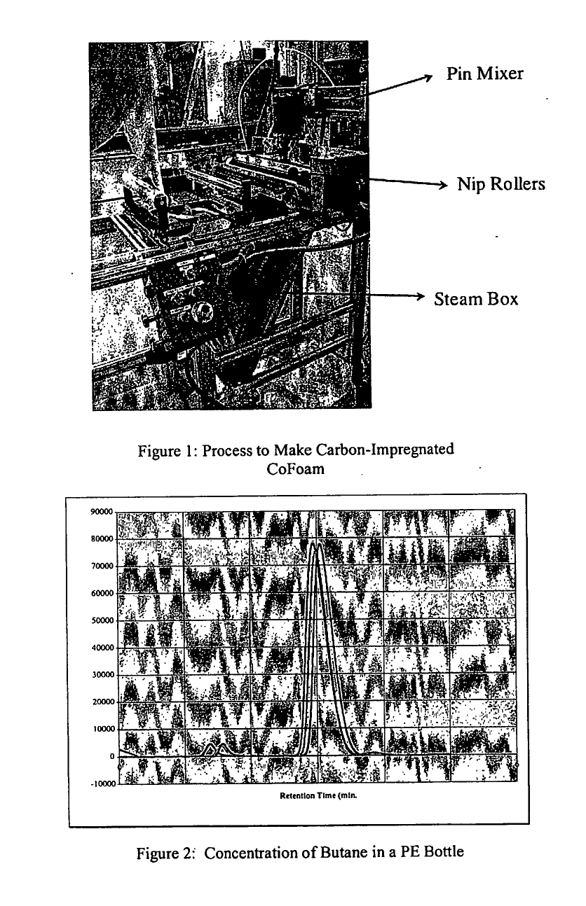

The slurry was transferred to the polyurethane composite production equipment for processing. A steam box was positioned immediately after the nip rollers. It was of sufficient size to ensure that the foam entering the box would have sufficient residence time to cure. Prior to the start of the run, steam was pumped through the box and the temperature checked to ensure it was ca, 100° C. This is shown in FIG. 1.

Once the proper temperature was achieved, the Meter/Mix was started using an MDI-based prepolymer and an aqueous of 0.1% Pluronic L62. Standard operating procedures were followed throughout the run. Upon establishment of a controlled operation, the valving was changed to introduce the carbon slurry to the mix head. The run was continued until the carbon slurry was consumed.

The run was then terminated. The carbon-incorporated foam was dried at 105° C. and bagged for subsequent analysis.

The amount of carbon was determined gravimetrically to be 29% by weight.

### EXAMPLE 4

A 1 liter polyethylene bottle was used for the extraction studies. The bottle was filled with a small amount of butane (approximately 0.2 grams). The bottle was capped and a 2 ml sample was withdrawn by inserting a syringe needle through the side. The sample was then injected into a gas chromatograph. The timer was started and a chromatogram recorded. Samples were taken over a period of 2 hours to ensure that the butane was not affected by the bottle itself. This is shown in FIG. 2.

A study sample was introduced into the bottle, capped, shaken for 10 seconds and a sample of the gas taken and analyzed as above. Evidence of extraction into the study sample is a decrease in the Butane peak height. A plot of the butane peak height versus the reaction time was considered a measure of the kinetics of extraction. The data was fitted to an equation of the form:
C_{butane}=A(Rt)^{-B}
where: C_{butane}=the butane peak height

A=the calculated intercept (a function of the initial concentration)

Rt=residence time of the carbon in the bottle

B is the slope of the line (the rate of extraction)

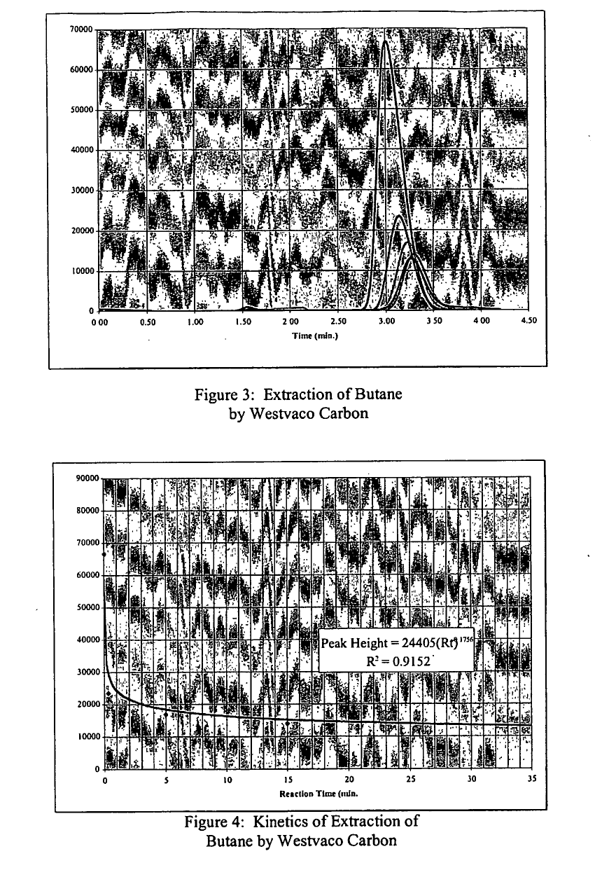

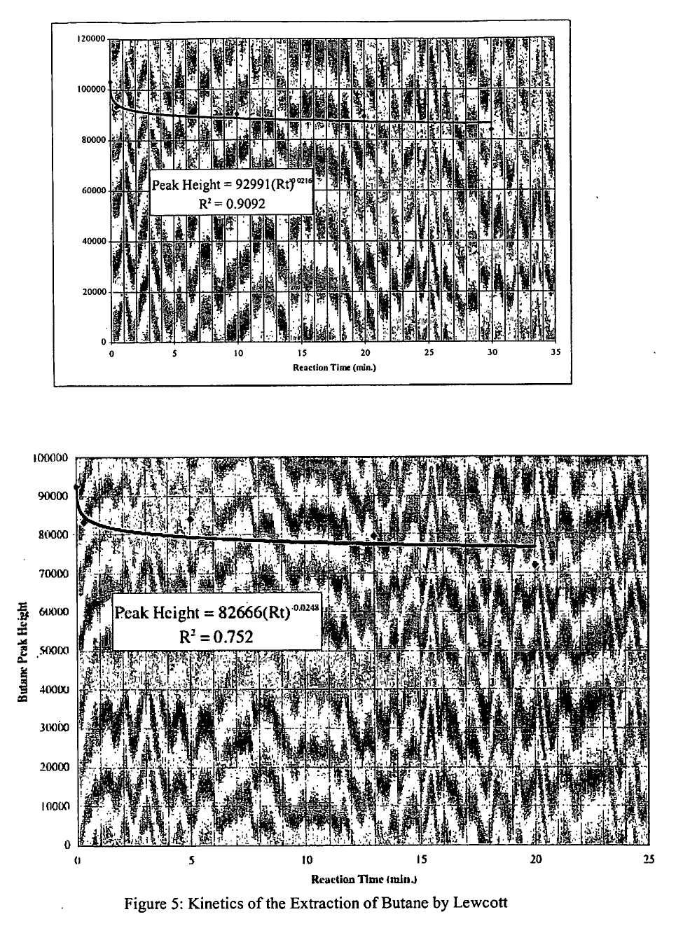

One gram of the Westvaco activated carbon was added to the bottle and the butane concentration was monitored. FIG. 3 shows the chromatograms and FIG. 4 shows a plot of the peak height versus reaction time with the equation which fits the curve to the data. It is clear from these data that the carbon is an effective extractor of butane under these conditions.

The procedure was then to introduce a foam sample into the newly charged and analyzed bottle of butane. Each foam sample was a 4.5″×4.5″ square of varying mass. All of the foam samples were pretreated in a 125° C. oven for an hour.

The first foam sample was a material supplied by Crest Foam. It was reported to be a carbon impregnated reticulated foam manufactured by Lewcott Corporation. It was designated as Activfiler™Media, CC-F 0.25-80 ppi-100. The kinetics of extraction is reported in FIG. 5.

Comparing the kinetics with the carbon data reveals that, relative to carbon, the Lewcott product has significantly lower activity. The slope of the carbon curve and the Lewcott curve (0.176 and 0.022, respectively) support this conclusion.

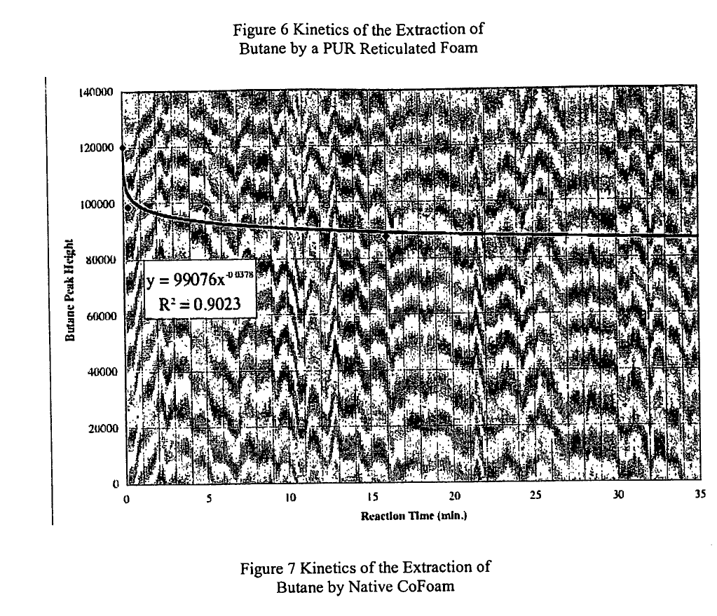

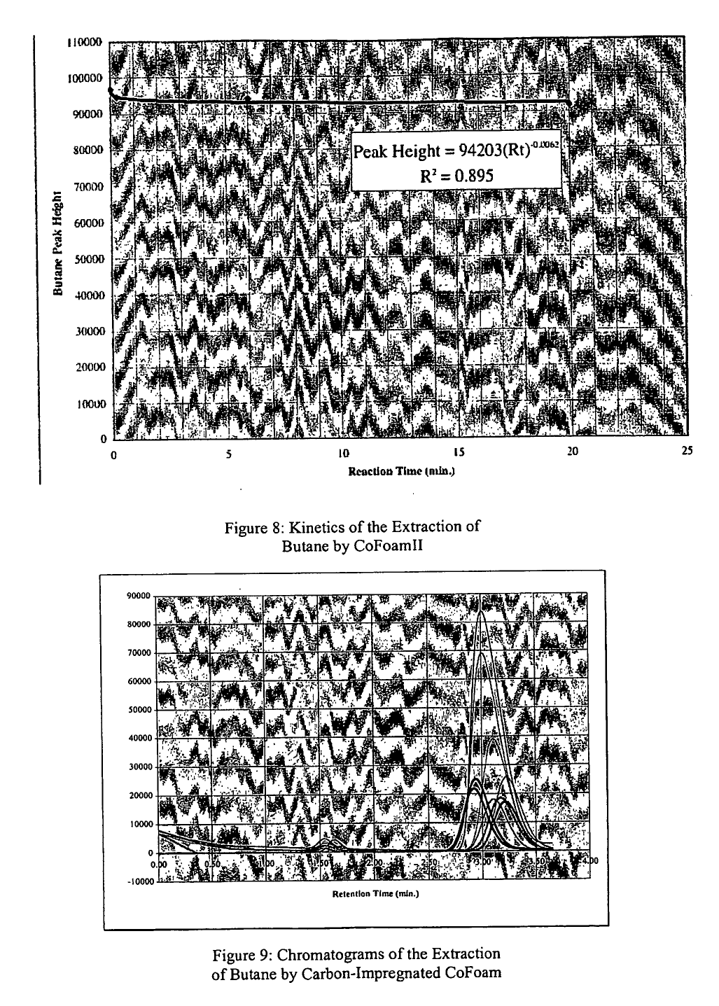

Other tests were conducted and the results are presented in FIGS. 6, 7 and 8.

FIG. 9 shows the analysis of the effect of the carbon impregnated polyurethane composite as described in the production method described above. These data show that the polyurethane composite produced by the technique taught herein is significantly improved in effectiveness. In each of the following extractions, the polyurethane composite contained about 1.7 grams of carbon. The chromatogram in FIG. 9 shows the ability of the composite to quickly reduce the butane concentration. It is a compilation of three separate extraction runs.

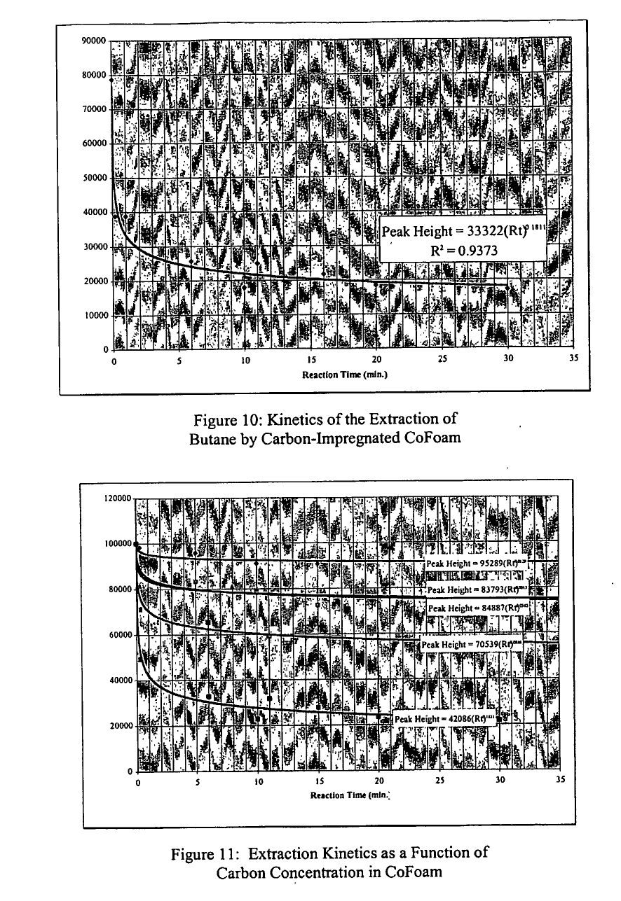

The kinetics of the extraction is reported in FIG. 10.

In an effort to confirm this extraction effect, samples of polyurethane composite were produced with increasing amounts of carbon. The amount of carbon in each was not determined but the relative amounts were determined by comparing the reflectivity to visible light.

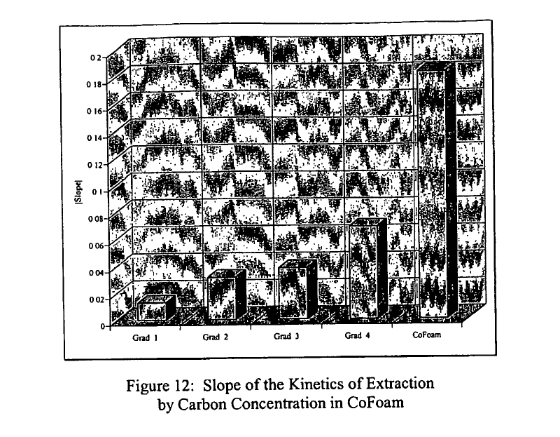

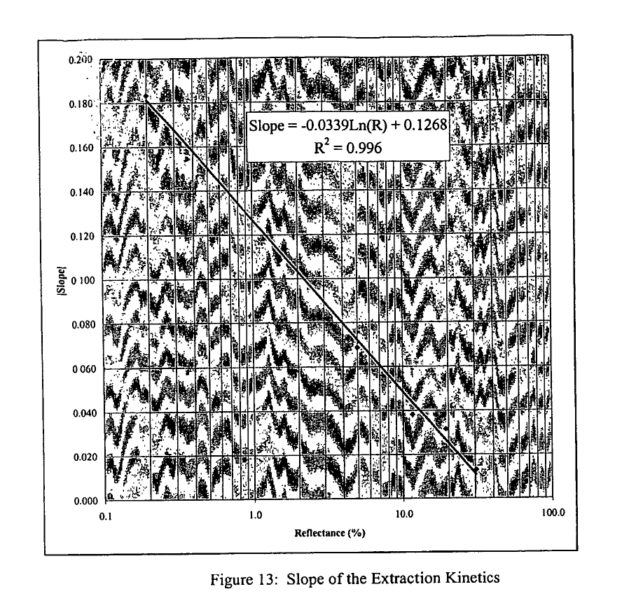

The kinetics of extraction are reported in FIG. 11. The slope of the curves in FIG. 12 show an exponential rise that is consistent with the increasing volume % of carbon. That increases the probability of carbon being at the surface of the polyurethane composite. A plot of the reflectance data, which is related to the carbon concentration as a function of reflectivity is shown in FIG. 13. The following table summarizes the data.

TABLE 1
Summary of the Slopes of Curves Plotting
the Kinetics of the Extraction

| | Slope of the |
|---|---|
| Sample | Curves |
| Westvac Carbon | 0.176 |
| Lewcott Media | 0.022 |
| Retculated Foam | 0.025 |
| Native CoFoam | 0.038 |
| CoFoamII | 0.020 |
| Polyurethane | 0.181 |
| composite w/29% | |
| Carbon (0% | |
| Reflectance) | |
| CoFoam (5% | 0.069 |
| Reflectance) | |
| CoFoam (12% | 0.032 |
| Reflectance) | |
| CoFoam (19% | 0.038 |
| Reflectance) | |
| CoFoam (30% | 0.013 |
| Reflectance) | |

What is claimed is:

1. A process of making a foam composite of desired pore size and confirmation which comprises:
(a) preparing an emulsion of a hydrophilic polyurethane prepolymer which upon curing forms a substantially open cell hydrophilic polyurethane polymer foam;
(b) contacting an open cell hydrophobic polyurethane foam having a plurality of surfaces defining a plurality of pores with said hydrophilic polyurethane prepolymer emulsion;
(c) curing said hydrophilic polyurethane prepolymer emulsion while in contact with said hydrophobic polyurethane by contacting said emulsion with a gas at elevated temperature for a period of time sufficient to form a coating of said substantially open cell hydrophilic polyurethane polymer foam on said hydrophobic polyurethane foam.

2. A process as recited in claim 1 wherein the temperature of the said curing step, the hiatus between steps (b) and (c) and the duration of said curing step are controlled to create a foam having the desired properties.

3. A process of making a foam composite containing a particular additive which comprises:
(a) preparing an emulsion of a hydrophilic polyurethane prepolymer which upon curing forms a substantially open cell hydrophilic polyurethane polymer foam;
(b) contacting a finely divided additive with a hydrocarbon gas and slurrying it in a fluid;
(c) emulsifying the said slurry of step (b) with the solution of prepolymer of step (a);
(d) contacting an open cell hydrophobic polyurethane foam having a plurality of surfaces defining a plurality of pores with said polyurethane prepolymer solution containing said additive and;
(e) curing said polyurethane prepolymer for a period of time sufficient to form a coating of said substantially open cell hydrophilic polyurethane polymer foam containing said additive on said hydrophobic polyurethane foam.

4. A process as recited in claim 3 wherein the curing step (c) is carried out by contacting the composite with a gas at elevated temperatures in order to create an additive—containing foam of desired porosity and confirmation.

5. A process as recited in claim 3 wherein the additive is activated carbon.

6. A foam composite made by the process of claim 1.

7. A foam composite made by the process of claim 3.
